(19) United States
(12) Patent Application Publication
(10) Pub. No.: US 2013/0023331 A1
(43) Pub. Date: Jan. 24, 2013

(54) ELECTRONIC THREE-DICE GAMING METHOD AND SYSTEM

(71) Applicant: Jamie Abrahamson, Las Vegas, NV (US)

(72) Inventor: Jamie Abrahamson, Las Vegas, NV (US)

(21) Appl. No.: 13/631,113

(22) Filed: Sep. 28, 2012

Related U.S. Application Data
(63) Continuation-in-part of application No. 13/601,596, filed on Aug. 31, 2012.
Application No. 13/601,596 is a continuation-in-part of application No. 11/487,213, filed on Jul. 14, 2006, now Pat. No. 7,694,969.

(51) Int. Cl. A63F 13/10; A63F 9/04

(52) U.S. Cl. 463/20; 463/18

(57) ABSTRACT

A method of playing a wagering game on an electronic gaming system has steps of: providing three virtual dice; providing in the memory an event result tables or paytables having a plurality of outcomes; the processor receiving a wager on an event result; effecting a virtual casting the three virtual dice to generate a random event using the electronic random number generator to determine an event outcome, the random event outcome comprising a display of the three virtual dice; comparing the random event of the virtual casting of the three virtual dice with the event result tables or paytables to determine wagering or game events; resolving wins or losses based upon the random event; and moving a virtual game piece on a virtual display; or both resolving wins or losses based upon the random event and moving a virtual game piece on the virtual display system.

### RELATED APPLICATIONS DATA

This application is a continuation-in-part application of copending U.S. patent application Ser. No. 13/601,596, filed 31 Aug. 2012 as a Reissue patent Application of U.S. Pat. No. 7,694,969, which issued from U.S. patent application Ser. No. 11/487,213, filed 14 Jul. 2006. The present application claims priority through the entire family of applications under 35 U.S.C. 120 and hereby incorporates by reference each of these applications and patent in the priority chain.

### BACKGROUND OF THE INVENTION

1. Field of the Invention

The present invention relates to the field of wagering games, particularly casino table wagering games and most particular casino table wagering games using dice or virtual dice or random number generators providing dice outcomes as the generators of random events.

2. Background of the Art

Dice games have been used for gambling and entertainment for centuries. Dice games are well known in the art. Craps is probably the best-known dice gambling game. Craps is representative of multiple roll dice games in which some types of bets are not resolved for two, three or more rolls of the dice. Some types of bets in Craps known as proposition wagers are resolved on one roll. The biggest problem with Craps, from the point of view of the player, is that the rules appear to be complex. Thus, it takes considerable study and/or playing time to learn to play with a level of comfort. These limitations are also the major problem with Craps from the point of view of the game operator (e.g., the casino). The apparent complexity of Craps intimidates some potential players who choose not to play or to play at minimum wagers and therefore lower the revenue of the casino.

Single roll dice games, such as those shown in U.S. Pat. No. 5,806,847 (White, et al.) are inherently simpler than multiple roll games such as Craps. However, the single roll dice games have fewer betting choices available to the players. Players tend to lose interest more easily in a game that has relatively few betting choices.

Some dice games increase the number of possible bets by using more than one or even more than two dice, such as the use of three dice of the same color (e.g., U.S. Pat. No. 5,879,006, Bowling). The game disclosed by Bowling also involves multiple rolls for some types of bets and complex rules to be learned by the player.

Another three dice game is disclosed in U.S. Pat. No. 6,209,874 (Jones). This game uses three dice, each a different color. The bets are resolved in one roll, which is simpler to learn than a multiple roll game. However, the use of three different color dice and bets involving the relative relationships of the outcome of the individual dice still results in a complex game that is likely to inhibit some potential players.

U.S. Pat. No. 4,334,685 (Robbins) describes a three dice wagering game using a playing surface that includes seven rows which are so demarcated by a line directed from the top to the bottom of the surface as to render each row into two sections. The area now at the left is identified by indicia explaining in detail the co-related area's purpose immediately to its right which is the betting area. Five such betting areas on the right side are further divided into a plurality of betting stalls, each stall having two components. One component, at the upper part thereof has indicia showing the betting ‘number’ and the other component at the lower part thereof has indicia showing the odds offered thereon. The remaining two betting areas on the right side are not divided but are emblazoned with indicia showing the type of bet therein and flanked on each side of the emblazonment with the odds offered therein. The combinations and permutations probability of the simultaneous ONE THROW OF THREE DICE (two WHITE dies and one RED die) which immediately completes each game has an indirect bearing on the odds shown in the plurality of betting areas. Various colors of betting chips are adapted to be selectively placed on the various betting units. However, each player must have a different identifying colored stack of chips from each of the other players and must be ‘paid-off’ in the same like-colored chip the bet was made with, which of course, coincides with the color of the stack of chips presently in front of the player.

U.S. Pat. No. 4,635,938 (Gray) describes a dice game using three dice of tetrahedron type. Two of the dice are colored white and the third die has four colors on separate surfaces, each colored surface having a differing numerical value as well. The play is commenced by first rolling the two white dice to obtain a numerical value of one of ten possibilities upon which first bets have been placed. The second roll utilizes the third colored die to determine the remainder of the wagering which include: odd/even, hard three, six, nine, and twelve; the total numerical value of the three dice, the listed numbers shown on each die, and the color and number of the third die.

U.S. Pat. No. 4,743,025 (Gramera) teaches a three dice game in which each of the two hundred sixteen possible numerical combinations of three six-sided dice is visually differentiated, one from the other, by retaining the six differently numbered faces on a conventional first neutral die; coding each of the six differently numbered faces on a second die with separate figure symbols; and coding each of the six numbered faces on a third die with separate colors and five different numbers. One of the faces of the third die repeats the number on one of the other faces of that die. Rolling the set of three dice over an extended period of time will display each of the expected fifteen numerical sums, ranging in values from three through seventeen, in two-hundred-sixteen separate and visually differentiated combinations, each turning up with equal odds of 1 in 216. Development of this coding technique, to separate and expand the normally expected fifteen numerical sums to two-hundred-sixteen numerical scores, by visually differentiating each of two-hundred-sixteen possible combinations of three six-sided dice, rolled with equal odds, affords a simplified but practical application to create a variety of new dice related games incorporating game boards, playing cards or a combination thereof.

U.S. Pat. No. 5,133,559 (Page) describes a gaming system in which a set of six dice provides two groups of intransitive dice, each group containing three dice (10, 20 and 30). The dice of one group are sized larger than those of the other group. Each die is one of three colors and each group of three intransitive dice includes a die of each color. The six dice are used in a casino game wherein all dice are rolled and then twelve possible bets are resolved. These bets fall into three categories: contests between two dice of the same size but different colors, contests between two dice of one color and two dice of another color, and contests matching two dice, each of a different color and different size versus another two dice, each of a different color and different size. Game apparatus includes a layout (40) providing twelve betting areas (A-L) and chips (50) for placing wagers on twelve possible bets.

U.S. Pat. No. 5,413,351 (Franklin) describes a dice game involving wagering on the outcome of a toss of three dies. A player places a first bet means. If the dealer throws a preselected winning combination, such as a 4-5-6, triple, or pair and a 6, the dealer wins. If the dealer throws a preselected losing combination, such as a 1-2-3 or a pair and a one, the dealer loses. If the dealer throws a third combination, such as a pair and a 2-3-4 or 5, then the player throws in an attempt to beat the dealer. If the player throws a preselected combination, such as a 4-5-6, or a pair and single die having a value higher than that of the dealer, the player wins. If the player throws a preselected loser, such as a 1-2-3, or a pair and single die having a value less than that of the dealer, the player loses. If the player or dealer does not throw one of above stated winning or losing combinations, then the dealer or player must throw again. Each player may place a second bet that the outcome of the game will result in predetermined winning die combination yielding a predetermined winning payout. A player may also place bonus bet means, wherein if that particular throw results in a preselected combination, such as triple sixes, the player is entitled to a throw. If the player throws another preselected combination, such as a triple six, the player is entitled to a large winning payout.

U.S. Pat. No. 5,505,457 (Boylan) describes a method of playing a wagering game simulating the sport of bowling where an outcome is determined by a random value symbol generator actuatable by a player. The method of play simulates the game of bowling. First and second predetermined range of values are selected by a house, and a round of the game is played by the player beginning with the wagering of a wager that a first generation of the value symbol will be within the first predetermined range of values or that a second generation of the value symbol when added to the first generated value symbol will be within the second predetermined range of values. The player then activates the random value symbol generator to produce a first value symbol, and then activates the random value symbol generator to produce a second value symbol where the first value symbol is not within the first predetermined range of values. Where the second value symbol is generated, the value of the first value symbol and the second value symbol are added together to generate a sum. Finally, settling of the wager occurs. Preferably, the wagering game further includes continuing a turn of the player by playing another round where the first value symbol is within the first range or the sum of the first and second value symbols is within the second range and the wagering that the player will play a predetermined number of consecutive rounds and/or will generate a first value symbol in the first range for a predetermined number of consecutive rounds.

U.S. Pat. No. 5,620,183 (Skratulia) describes a game in which a set of dice (20, 120) produces a range of numerical values including a plurality of diced each having a representation of a selected number disposed on each of its six sides. In one embodiment the set of dice 20 includes first die 22, second die 24, and third die 26, and the range of numerical values produced is one through eight. In a second embodiment the set of dice 120 includes first die 122 and second die 124, and the range of numerical values produced is one through nine. A method for randomly generating one of the numbers one through eight or one through nine, with each number one through eight having an equal 0.125 probability of being generated, comprising the steps of: providing first, second, and third six-sided dice, said first die having a representation of the number zero disposed on three sides and a representation of the number two disposed on three sides; said second die having a representation of the number one disposed on three sides and a representation of the number two disposed on three sides; and, said third die having a representation of the number zero disposed on three sides and a representation of the number four disposed on three sides; rolling said first, second, and third six-sided dice, after rolling said first, second, and third six-sided dice, each die having an uppermost side; and, numerically totaling said uppermost sides of said first, second, and third six-sided dice.

U.S. Pat. No. 6,893,019 (Gaygen teaches a casino-type table betting game using one die of one color, or otherwise singularly marked, and two matching dice of another color, or otherwise marked as a pair. Players make wagers on the outcome of a single roll of the three dice. Wagers are made by placing bet markers on various areas of a game board that define bet types. One group of wagers is on the outcome of the singular die. A second group of wagers is on the pair of dice. A third group of wagers is on the total of all three dice. When the outcome of the singular die is a predetermined number (e.g., 1), the house wins all bets on the game board regardless of the outcome of the other two dice. A method of playing a dice game has a dealer, who is an agent or employee of a game operator or house, and a plurality of players comprises the steps of: a) providing one of said players with two dice of one color, or otherwise identified as a pair, and one die of another color, or otherwise identified as a singleton, or electronic or other representations thereof, said dice being hexahedral and each side of each die marked with a different indicia representing a number from one to six inclusive; b) providing a game surface, or electronic or other representation thereof, having a betting area where said players make bets by placing a betting marker or markers, said betting area having one section for placing bets on the outcome of said single die including only outcomes 2, 3, 4, 5, and 6, one section for placing bets on the outcome of said pair of dice including outcomes 2, 3, 4, 5, 6, 7, 8, 9, 10, 11, and 12, one section for placing bets on the total of all three said dice including only outcomes 4, 5, 6, 7, 8, 9, 10, 11, 12, 13, 14, 15, 16, 17, and 18, one section for ancillary bets related to the outcome of said single die, one section for ancillary bets related to the outcome of said pair of dice, one section for ancillary bets related to the outcome of all three said dice, said game surface having no section for placing bets on said single die having an outcome of 1, wherein the dice game does not allow for the placing of bets on the single die outcome of 1; c) providing payout odds for a winning bet for each bet on the game surface; d) said players placing bets on said game surface; e) said shooter rolling all three said dice together completing one play of said game; f) said dealer determining winning bets by determining which bets match the outcome of the roll of the dice when the outcome of said single die is 2, 3, 4, 5, or 6; g) said dealer taking possession of said betting markers on losing bets and paying said players making winning bets according to payout odds; h) said dealer taking possession of any and all said betting markers anywhere on said game surface when the outcome of said single die is 1.

Various three-dice board games and wagering games also include U.S. Pat. No. 5,791,651 (Bryant); U.S. Pat. No. 5,879,006 (Bowling); and U.S. Pat. No. 6,378,869 (Hedge et al.). In spite of the options available for dice games, the only game that has established a following at casinos is traditional craps games. It is believed that a novel game with simplicity of play and ancillary topical interest can be a novel game that attracts new players and can maintain interest. All references cited herein are incorporated by reference in their entirety.

### SUMMARY OF THE INVENTION

A gaming system and gaming play use three dice (physical dice or virtual dice) to provide random events. The random events are related to physical or distance movements or points scored on a field or track or map. The dice are provided as two dice representing a portion of the random event determinant and the third die acting as a separate portion of the event determinant, such as a selector for a particular column in an event result table. The first two dice are differentiated from the third die by obvious physical and visually observable characteristics, such as size and/or color. At least one wager is placed on the game by at least one player, and the dice are cast to provide the random outcome. The wager may be a running event wager or a proposition bet. The total of the two dice in combination with the particular symbol provided by the third die determine event results such as a single roll win, a single roll loss or an advancement of a gaming object in a continuing step in the game. An array of different wagers may be offered to players for both continuing wagers and proposition bets. The format of the game table and play surface can be designed to offer a theme in which the wagers and the random dice outcomes can be related to the theme. For example, in using an American Football theme, winning and losing events can be provided by dice roll outcomes equated to touchdowns, interceptions, extra-points, penalties, first downs and the like.

### BRIEF DESCRIPTION OF THE FIGURES

FIG. 1 shows three dice that may be used in the practice of the technology described herein.

FIG. 1A shows a standalone terminal that may be used to play a game according to the present technology.

FIG. 2 shows a game table layout using part of an American Football layout to represent results of dice rolls in the play of the game described herein.

FIG. 2A shows a schematic for a non-limiting example of an electronic configuration on which the presently described technology may be practiced.

FIG. 3 shows a result table or event table or the rolls of the dice.

FIG. 4 shows a flowchart of game play.

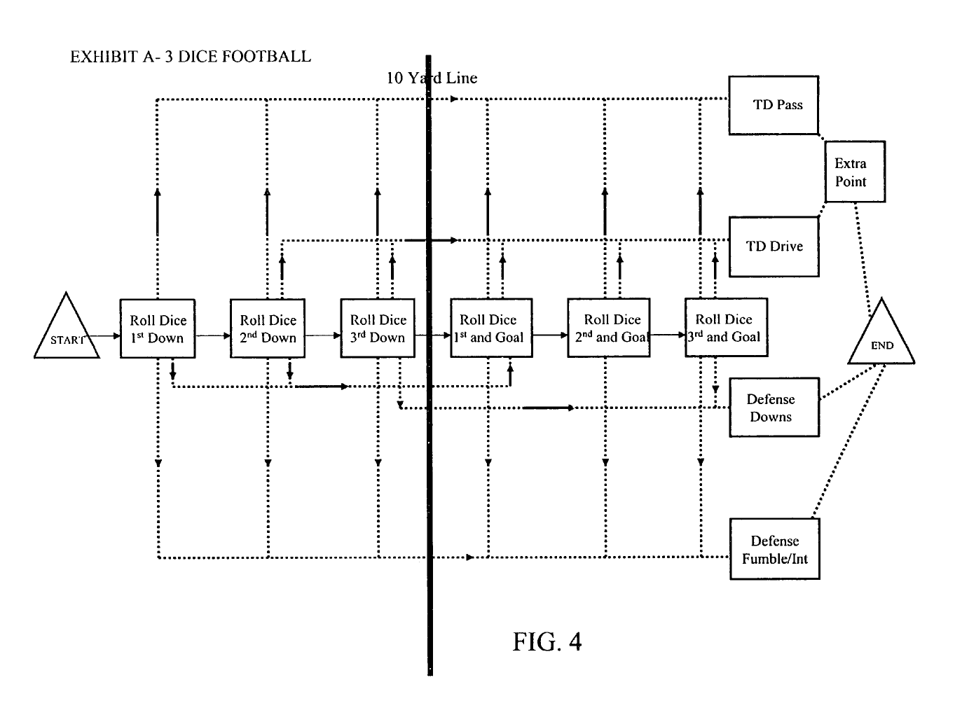

### DETAILED DESCRIPTION OF THE INVENTION

A board game, casino table wagering game, video game, internet game or internet wagering game simulates events in an American Football game or other field game (e.g., soccer, baseball, cricket, field hockey, ice hockey, lacrosse, horse racing, dog racing, track-and-field and the like) by providing a gaming field (or virtual gaming field) on which a game piece, marker, virtual game piece or virtual marker is moved as the result of random numerical events determined by three dice. As in craps, a series of rolls or possessions can be played while attempting to achieve an ultimate event (e.g., touchdown, run, goal, first down, etc.) while the player(s) of the game make wagers as to the outcome of the total game activity (a touchdown or loss of possession) or the events of single rolls (proposition wagers and winning/losing outcomes, first downs, interceptions, fumbles, etc.). Although there are many variations in the nomenclature of events because of the use of different sports themes in the play of the game, there is a unifying feature with regard to the equipment, probabilities, events, payout odds, house hold and other elements of the game. The fact that the game can be provided in many different formats with the same or similar underlying features in the game play should be remembered, even though the description of the game will emphasize American football terminology, and these descriptions are not intended to limit the game to that single theme. Instead, the use of American football terminology is intended to be a description of a species of play within the generic concepts of the broad invention.

A field is present as a design on a table or a virtual image on a screen and three dice are used as the random event generator. The dice preferably are standard appearance die, with six faces and numbering symbols of 1, 2, 3, 4, 5 and 6 on the faces of the dice. At a minimum, the two similar dice should be standard dice with one of six different number indicators on each of the six faces of the die. The third die may be physically observably distinct from the first two dice, and may also have standard numbering on its facing, but may also have other symbology (e.g., A, B, C, D, E and F; six different team logos; etc.) on their faces, as the symbols or numbers on the third die are not necessarily used to form a total number for use in the game, but rather tends to be used to select an event result table during the play of the game. This fact will be explained in greater detail later.

Standard dice have opposed faces that total a number 7, but this is not essential in the practice of the invention. The dice are designed with two dice being essentially within a single grouping (e.g., the same size, the same color or combinations thereof) and one die in a distinct grouping (e.g., a different size, a different color or combinations thereof, different symbology on the faces, and combinations of these).

The game described herein will be referred to as “3 Dice Football”™ and is a fast paced and exciting table game, which uses 3 dice to play the game. 3 Dice Football™ is intended as a gambling game for use in Casinos, but may be used on the internet, on video wagering apparatus, as a video game or a board game.

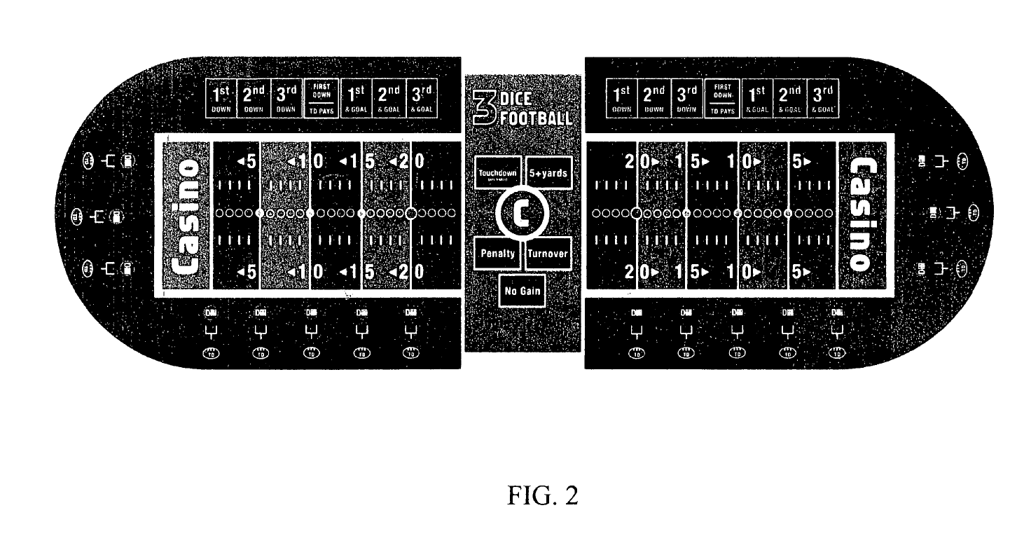

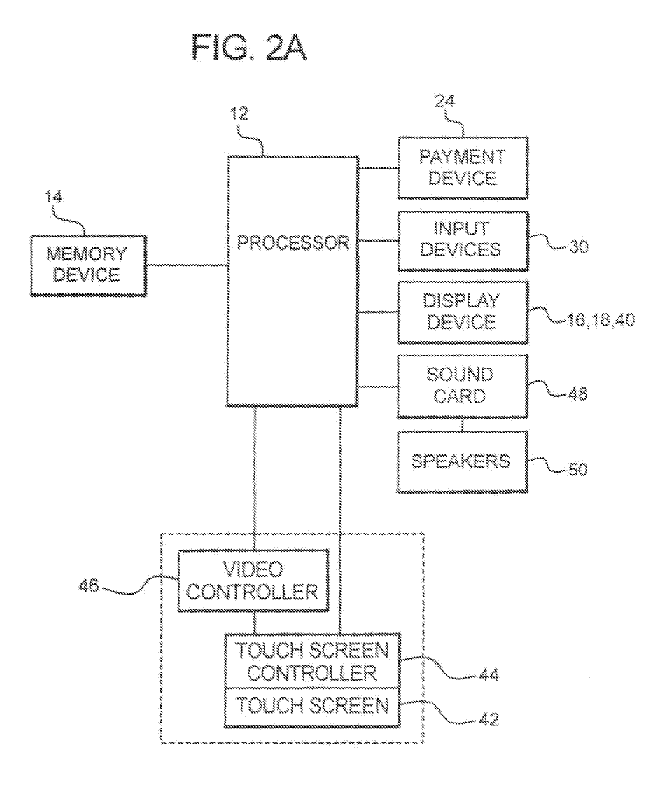

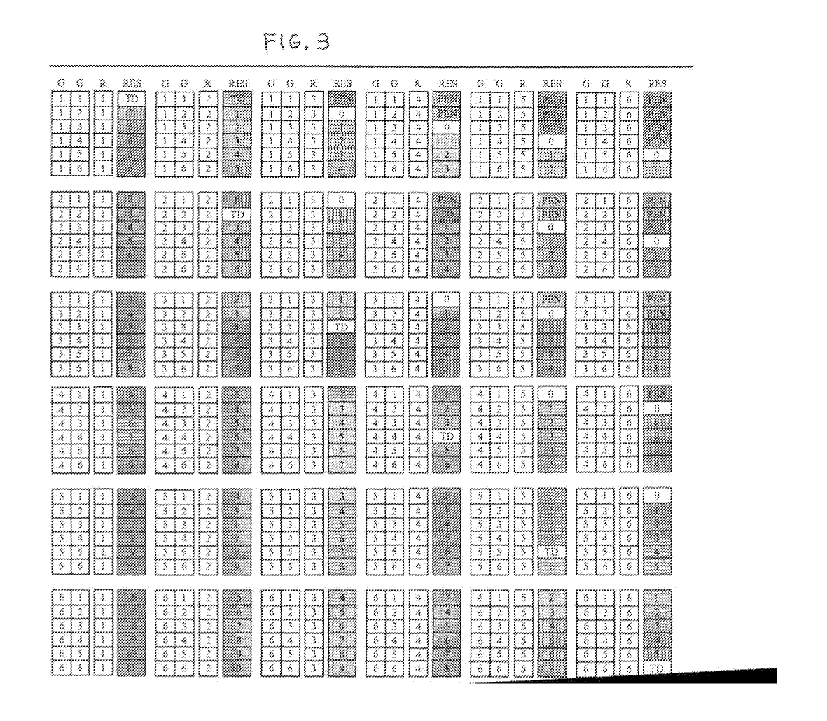

Game Objective and Rules: (See FIGS. 2 and 3)

The primary apparent objective of the game is to place a wager and score a Touchdown, although wagers may be placed on various events, including not scoring a touchdown. The Three-Dice Football™ game begins with a game piece or position indicator being placed at a start location on the field. For example, the “football” being moved by events in the play of the game (e.g., which may be represented on the game table by a small football helmet) placed on the offensive twenty (20) yard line. The roller of the dice (known as the ‘quarterback’) begins by rolling three (3) dice (e.g., two (2) six-sided green dice and one (1) six-sided red die). The dice determine the outcome of the play (see the table of FIG. 3 in Exhibit B). In the ordinary play of the game, the quarterback has three (3) plays (three rolls of the three dice) to reach the ten (10) yard line (known as achieving a ‘1st down’). There is only one (1) 1st down possible per game. If a 1st down is achieved, the quarterback then has three (3) additional plays to score a Touchdown. A Penalty can occur on any play as shown by PEN in the table of FIG. 3 (Exhibit B). A penalty results in a loss of the current down and a loss of one (1) yard. An ‘Instant Touchdown,’ or ‘Turnover’ can occur on any play, as also shown in the table of FIG. 3 (Exhibit B). Whenever a Touchdown is scored, the quarterback rolls the dice one (1) time (known as ‘extra-point’) and there is a separate potential for extra-point payouts. After the extra-point roll, that round of the game ends. If a Touchdown is not scored in the designated number of plays, or if a Turnover is rolled, that round of the game ends, just as if a shooter has crapped out in Craps.

Different Bets: All players at the table may bet on any or all of the following proposition bets, and all final payouts are to be determined by the Casino. The payouts listed below are suggestions only and are not intended to limit the scope of the game or the scope of payouts available.

Touchdown: This bet must be made at the beginning of the game. This bet wins if a touchdown is scored. The payout is 1:1.

Extra-Point: This bet must be made at the beginning of the game. If a touchdown is scored, one (1) roll is made with three (3) dice. The payout is as follows: If one (1) of the dice contains the number one, the payout is 1 for 1; if two (2) of the dice contain the number one, the payout is 10 for 1; if all three (3) dice contain the number one (or the two similar dice are “one” (1) and a specific single symbol appears on the third die (e.g., a Super Bowl™ game symbol), the payout may be approximately 175 for 1.

Defense: This bet must be made at the beginning of the game. This bet wins if a touchdown is not scored, or a turnover is rolled. The payout is to be determined (TBD).

First Down: This bet must be made at the beginning of the game. This bet wins if a first down is achieved or a touchdown is scored. The payout is TBD.

No First Down: This bet must be made at the beginning of the game. This bet wins if both a first down is not achieved and a touchdown is not scored. The payout is TBD.

Touchdown on Down (‘X’): This bet must be made at the beginning of the game. This bet wins if a touchdown is scored on the correct down. The payouts vary by down and are TBD.

Touchdown (1 Play): This bet can be made at the beginning of any play. This bet wins if an ‘instant touchdown’ is scored (see Exhibit B). A touchdown scored by yards gained does not qualify for this bet. The payout is 30:1.

Turnover (1 Play): This bet can be made at the beginning of any play. This bet wins if a turnover occurs (see Exhibit B). A turnover by downs does not qualify for this bet. The payout is 60:1.

Penalty (1 play): This bet can be made at the beginning of any play. This bet wins if a penalty occurs (see Exhibit B). The payout is 9:1.

No Gain (1 play): This bet can be made at the beginning of any play. This bet wins if zero (0) yards are gained, or if a penalty occurs, or if a turnover occurs. The payout is 5:1.

5 yards+(1 play): This bet can be made at the beginning of any play in which the football is marked on the five (5) yard line or beyond. This bet wins if five (5) or more yards are gained, or if an ‘instant touchdown’ is scored. The payout is 9:8.

Possible Design Ideas:

The outside and top of the game table can resemble a football stadium. The three dice can be placed in a small devise that resembles a football; the ‘quarterback’ would then roll this devise down the table. The object that marks what yard line the football is on can be a small football helmet. The quarterback can choose from 2 different colored helmets (home/away) before each game. The helmet can contain the casino logo on the side of the helmet. The table can contain digital displays to provide game information similar to a digital scoreboard at a football stadium.

The digital displays can also be used for marketing purposes. The side panels on the inside of the game table can be used as advertising space for sponsors. The marker that indicates what down it is can be a small object in the shape of a football with a logo of the casino on it. The field can represent any sports or wagering playing field by merely altering the art work. The changes are obvious in simply shifting from American Football to soccer, field hockey or even basketball and ice hockey. The changes to such events as a horse race (e.g., complaint changed for penalty; passing field at a turn changed for first down; stumbling for penalty; falling for interception; etc.) are more subtle, but equally effective in maintaining the ambiance of the sporting event and yet retaining the identical or at least similar event outcomes with the rolls of the dice (according to Exhibit B). The Table of FIG. 3 provides event outcomes determined by the outcomes shown in the table, wherein RES is a result, TD is a touchdown, TO is a turnover, PEN is a penalty and G is a value on a die. Other Variations: A ‘kickoff’ roll of the dice can be used to determine starting field position at the beginning of the game. The Extra-Point bet can be a ‘bonus’ type bet with a dollar limit set. An additional bet is whether an instant touchdown, turnover, or penalty will occur during the game. An additional bet is how many plays the game will last. An additional bet is how many yards an individual play will result in. The general game may be described as follows. A wagering game comprises the steps of:

a) a player placing at least one wager to play in the wagering game;

b) a player, the house or a mechanical device casting three dice to generate a random event. The three dice consist of two dice whose exposed numbers are used to define a numeric result, and the third die is used to characterize that numeric result in event result tables or paytables;

c) the random event of the casting of the three dice is compared with event result tables (e.g., see FIG. 3) and then with the paytables to determine wagering or game events from the random event; and

d) wins or losses based upon the random event are resolved; moving a game piece in a continuing of the wagering game; or both resolving wins or losses based upon the random event and moving a game piece in a continuing of the wagering game. The wagering game may have the two dice with six faces, wherein each face has a number indicator of only one of 1, 2, 3, 4, 5 or six thereon, and each of the six faces has a different number indicator thereon, as is typical with a standard Craps die. The third die has a visual appearance distinguishing the third die from the two dice, as with a different color, a different size, different symbology on the faces (e.g., numbers 1, 2, 3, 4, 5 and 6, rather than the appropriate numbers of spots; different team symbols; different player symbols; different astrological symbols; or any other visually distinguishable markings or coloration of the die and its faces. In the game, a physical or virtual surface is used to move a game piece an amount related to the numeric total of the two dice and an event result table and/or a paytable is associated to the numeric result by a random outcome on the third die according to rules of play of the game. The wagering game preferably provides a surface that has markings and words relating the wagering game to a sporting event, such as for American Football. In the wagering game, the event outcome or event result table is separate from a paytable and the event outcome or event result table (FIG. 3) identifies at least touchdowns, distance of ball movement and penalties according to the combination of numerical result from the two dice and the specific results associated with displayed symbology on the third die. In the wagering game, after a touchdown occurs in the wagering game, at least one die may recast to determine if an extra point wagering event is achieved. The wagering game allows that proposition wagers may be placed on at least one proposition wager event determined by the casting of the three dice selected from the group consisting of a) a one-roll touchdown; b) a one-roll first down (preferably there is no instant one roll first down—a first down ordinarily can only be achieved by moving the football at least ten yards; even though some rolls are 10 yards or more outcome it is not an automatic first down—on each roll a player needs a different number of yards to get a first down); c) a one roll penalty; a one roll specific yardage result; and d) a one-roll turnover (interception or fumble).

The technology may be practiced, for example, as a virtual electronic system or preferably as a gaming system for playing the wagering game described above comprising:

a gaming table having an upper surface with indicia thereon indicating distances and positions for moving the game piece;

the game piece for placement on the upper surface; and

three dice, the three dice comprising two dice for defining the numeric result and a third die that is visually distinguishable from the two dice for characterizing that numeric result in event result tables or paytables. The gaming system may have the indicia represent field position on an American Football playing field and betting areas are provided for placing wagers on at least one of touchdowns, first downs, penalties, no touchdowns, and no first downs. The odds for specific outcomes are printed on the upper surface.

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

FIG. 2A shows an example of a schematic for a non-limiting example of an electronic configuration on which the presently described technology may be practiced. The system shown comprises a memory device 14, a processor 12, associated with a payment device 24, input device 30, display devices 16, 18, 40, sound card 48, speakers 50, video controller 46, touch screen controller 44 and touch screen 42.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In some embodiments, a server computer and one or more client computers may perform desired actions. Actions may be performed by one or more of the clients and/or servers in accordance with a desired distribution of labor. Such distribution of labor may be made based on where the actions may be performed more securely, more quickly, and/or more cost-effectively. For example, in some implementations, complex calculations may be performed by a central server to increase speed, display related calculations may be performed by a client because they may be simple, outcome determining calculations may be performed by a central server in order to ensure the validity of the calculations and allow tweaking of odds to be performed at a single location. It should be recognized that any desired actions may be divided among a server and any number of clients in any desired way.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

In one embodiment, as illustrated in FIG. 2A, the gaming device preferably includes at least one processor 12, such as a microprocessor, a microcontroller-based platform, a suitable integrated circuit or one or more application-specific integrated circuits (ASIC's). The processor is in communication with or operable to access or to exchange signals with at least one data storage or memory device 14. In one embodiment, the processor and the memory device reside within the cabinet of the gaming device. The memory device stores program code and instructions, executable by the processor, to control the gaming device. The memory device also stores other data such as image data, event data, player input data, random or pseudo-random number generators, pay-table data or information and applicable game rules that relate to the play of the gaming device. In one embodiment, the memory device includes random access memory (RAM), which can include non-volatile RAM (NVRAM), magnetic RAM (MRAM), ferroelectric RAM (FeRAM) and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical and/or semiconductor memory may operate in conjunction with the gaming device disclosed herein.

In one embodiment, part or all of the program code and/or operating data described above can be stored in a detachable or removable memory device, including, but not limited to, a suitable cartridge, disk, CD ROM, DVD or USB memory device. In other embodiments, part or all of the program code and/or operating data described above can be downloaded to the memory device through a suitable network.

In one embodiment, an operator or a player can use such a removable memory device in a desktop computer, a laptop personal computer, a personal digital assistant (PDA), portable computing device, or other computerized platform to implement the present disclosure. In one embodiment, the gaming device or gaming machine disclosed herein is operable over a wireless network, such as part of a wireless gaming system. In this embodiment, the gaming machine may be a hand held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission. It should be appreciated that the processor and memory device may be collectively referred to herein as a “computer” or “controller.”

In one embodiment, as discussed in more detail below, the gaming device randomly generates awards and/or other game outcomes based on probability data. In one such embodiment, this random determination is provided through utilization of a random number generator (RNG), such as a true random number generator, a pseudo random number generator or other suitable randomization process. In one embodiment, each award or other game outcome is associated with a probability and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome.

In another embodiment, as discussed in more detail below, the gaming device employs a predetermined or finite set or pool of awards or other game outcomes. In this embodiment, as each award or other game outcome is provided to the player, the gaming device flags or removes the provided award or other game outcome from the predetermined set or pool. Once flagged or removed from the set or pool, the specific provided award or other game outcome from that specific pool cannot be provided to the player again. This type of gaming device provides players with all of the available awards or other game outcomes over the course of the play cycle and guarantees the amount of actual wins and losses.

In another embodiment, as discussed below, upon a player initiating game play at the gaming device, the gaming device enrolls in a dice game. In this embodiment, a dice roller or croupier calls the dice outcomes that result in a specific dice game roll outcome. The resultant game outcome is communicated to the individual gaming device to be provided to a player. In one embodiment, this dice outcome is displayed to the player as a dice game and/or in any form in accordance with the present disclosure.

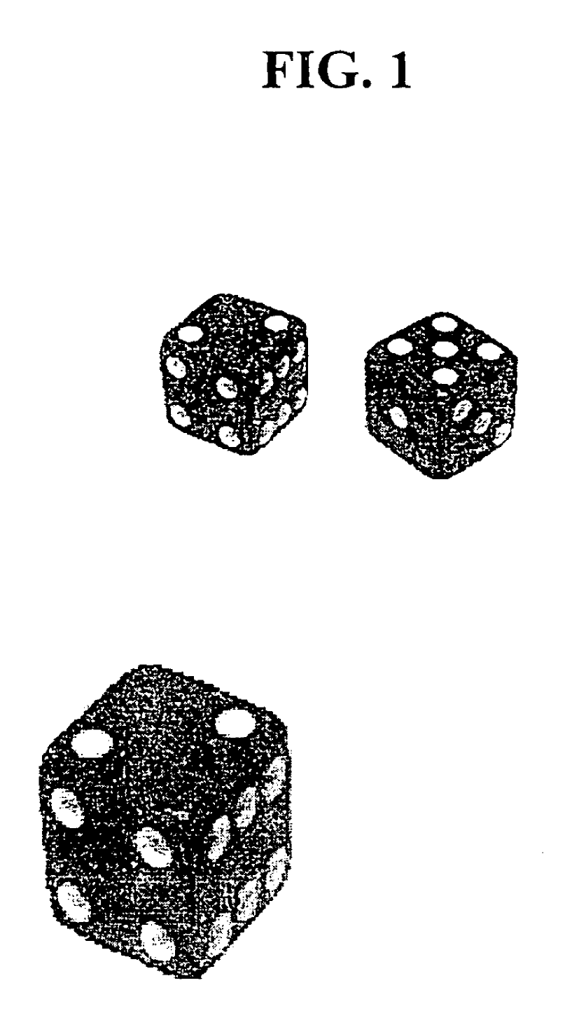

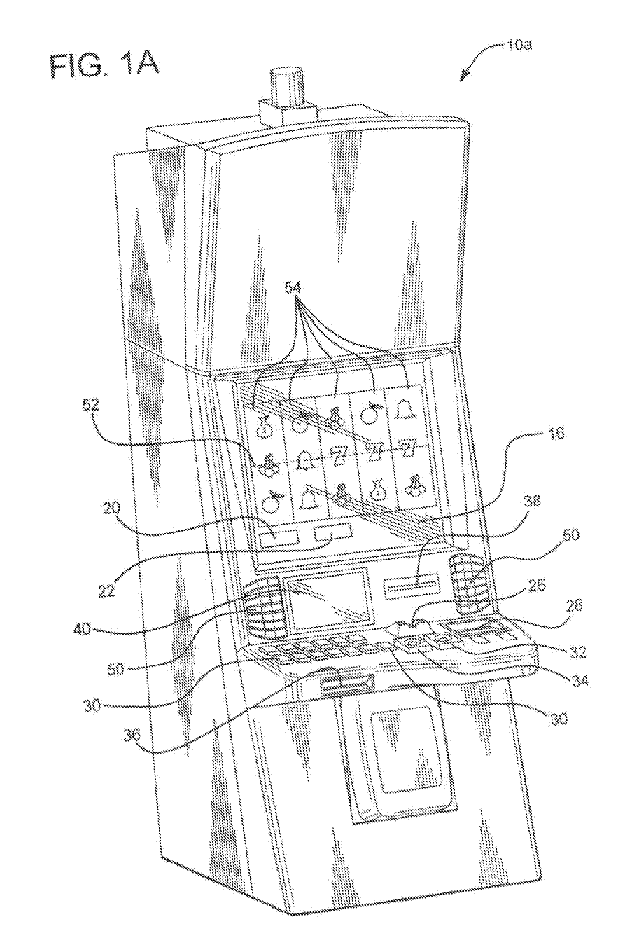

In one embodiment, as illustrated in FIG. 2A, the gaming device includes one or more display devices controlled by the processor. The display devices are preferably connected to or mounted to the cabinet of the gaming device. The embodiment shown in FIG. 1A includes a central display device 16 which displays a primary game. This display device may also display any suitable secondary game associated with the primary game as well as information relating to the primary or secondary game. The upper display device may display the primary game, any suitable secondary game associated or not associated with the primary game and/or information relating to the primary or secondary game. These display devices may also serve as digital glass operable to advertise games or other aspects of the gaming establishment. As seen in FIG. 1A, in one embodiment, the gaming device includes a credit display 20 which displays a player's current number of credits, cash, account balance or the equivalent. In one embodiment, the gaming device includes a bet display 22 which displays a player's amount wagered. In one embodiment, as described in more detail below, the gaming device includes a player tracking display 40 which displays information regarding a player's playing tracking status.

In another embodiment, at least one display device may be a mobile display device, such as a PDA or tablet PC, that enables play of at least a portion of the primary or secondary game at a location remote from the gaming device.

The display devices may include, without limitation, a monitor, a television display, a plasma display, a liquid crystal display (LCD) a display based on light emitting diodes (LED), a display based on a plurality of organic light-emitting diodes (OLEDs), a display based on polymer light-emitting diodes (PLEDs), a display based on a plurality of surface-conduction electron-emitters (SEDs), a display including a projected and/or reflected image or any other suitable electronic device or display mechanism. In one embodiment, the display device includes a touch-screen with an associated touch-screen controller. The display devices may be of any suitable size and configuration, such as a square, a rectangle or an elongated rectangle.

The general scope of the invention may include methods and systems as follows. A method of playing a wagering game on an electronic gaming system may have, for example:
a) a central processor;
b) a video display system;
c) data entry systems in communication with the central processor;
d) an electronic random number generator in communication with the central processor; and
e) memory containing look-up tables of event result tables;

The method may have steps of:
providing three virtual dice that are displayed on the video display system, a first two virtual dice of the three virtual dice having a plurality of virtual faces and each virtual face having a virtual number indicator, the third virtual die having a plurality of virtual faces and each virtual face having a virtual number indicator, the third virtual die having a visual appearance that is distinct from the visual appearance of the first two dice;
providing in the memory an event result tables or paytables having a plurality of outcomes;
the processor receiving a wager on an event result through a signal originating from the data entry system, the at least one wager being on the wagering game;
effecting a virtual casting of the three virtual dice to generate a random event using the electronic random number generator to determine an event outcome,
the random event outcome comprising a display of the three virtual dice consisting of two virtual dice whose exposed virtual numbers are used to define a numeric result corresponding to a particular partial outcome of an event and the third virtual die being used with the particular partial outcome to determine a final event outcome within the game from the event result tables;
comparing the random event of the virtual casting of the three virtual dice with the event result tables or paytables to determine wagering or game events from the random event;
resolving wins or losses based upon the random event; and
a) moving a virtual game piece on a virtual display on the video display system in a continuing of the wagering game; or
b) both resolving wins or losses based upon the random event and moving a virtual game piece on the virtual display system in a continuing of the wagering game.

The two virtual dice have six virtual faces and each virtual face has a number indicator of only one of 1, 2, 3, 4, 5 or six thereon, and each of the six virtual faces has a different number indicator thereon, and the third virtual die has six virtual faces and each virtual face has a number indicator of only one of 1, 2, 3, 4, 5 or six thereon, and each of the six virtual faces has a different number indicator thereon. A virtual game field surface is displayed on the video display system and is used to display movement of a game piece a virtual amount related to the numeric total of the two virtual dice and the paytable associated to the numeric result by a random outcome on the third virtual die according to rules of play of the game stored in the memory. The virtual game field surface may have markings and words relating the wagering game to a sporting event, such as for soccer or where the sporting event is American Football. The event outcome table is separate from the paytable and the event outcome table identifies at least touchdowns, distance of ball movement and penalties according to the combination of numerical result from the two virtual dice and the specific results associated with displayed symbology on the third virtual die. The method may be played wherein after a touchdown occurs in the wagering game, at least one virtual die is recast to determine if an extra point wagering event is achieved. The proposition wagers, if any, are recognized by the processor from the data entry system, the proposition wager being on at least one proposition wager event determined by the virtual casting of the three virtual dice selected from the group consisting of a) a one-roll touchdown; b) a one-roll turnover; c) a one roll penalty; and d) a one roll specific yardage result.

The event outcome is determined by the processor executing code to compare the virtual gaming event outcome from the virtual casting of the virtual three dice and the event results table. The proposition wagers may be recognized as being on at least one proposition wager event determined by the casting of the three virtual dice selected from the group consisting of a) a one-roll touchdown; b) a one-roll turnover; c) a one roll penalty; and d) a one roll specific yardage result. The processor displays at least one of the event result tables on the video display system and indicates virtual game piece movement on a virtual playing field as a result of comparing the random event of the virtual casting of the three virtual dice with the event result tables or paytables to determine wagering or game events from the random event. The data entry systems are selected from the group consisting of hand-held wireless communication devices, networked television systems, keypads, stand-alone wagering terminals, personal computers on a network or internet and banks of wagering terminals.

A gaming system for playing the wagering game may have, as described in greater detail above:
a) a central processor;
b) a video display system;
c) data entry systems in communication with the central processor;
d) an electronic random number generator in communication with the central processor; and
e) memory containing look-up tables of event result tables.

The video display system displays an image of both a virtual game piece and a gaming table upper surface with virtual indicia thereon indicating distances and positions for moving a virtual game piece;
the virtual game piece being displayed on the virtual display system at a position on the virtual upper surface; an event result tables or paytables having a plurality of outcomes arranged in rows and columns; and
the video display system displays three virtual dice, the three virtual dice comprising two virtual dice for defining the numeric result corresponding to a particular partial event on the look-up tables or paytables, and a third virtual die that is visually distinguishable from the two virtual dice for providing a visual appearance that is distinct from the visual appearance of the first two virtual dice, and the third virtual die used to define a number corresponding to a final event outcome defined in the look-up tables or paytables to determine an outcome of that numeric result from the first two dice in event result tables or paytables. The indicia represent field position on an American Football playing field and betting areas are provided for placing wagers on at least one of touchdowns, first downs, penalties, turnovers, no touchdowns, and no first downs. The gaming system may use data entry systems such as a component selected from the group consisting of wagering terminals, desktop processors with individual display systems, hand-held communication devices and laptop computers. The communication may be hardwired, wireless or through the internet. The gaming system may use data entry systems of a portable component selected from the group consisting of cellular phones, wireless tablets, wireless pads and laptop computers.

The display devices of the gaming device are configured to display at least one and preferably a plurality of game or other suitable images, symbols and indicia such as any visual representation or exhibition of the movement of objects such as mechanical, virtual or video reels and wheels, dynamic lighting, video images, images of people, characters, places, things and faces of cards, and the like.

What is claimed:

1. A method of playing a wagering game on an electronic gaming system, the electronic gaming system comprising:
a) a central processor;
b) a video display system;
c) data entry systems in communication with the central processor;
d) an electronic random number generator in communication with the central processor; and
e) memory containing look-up tables of event result tables;
the method comprising the steps of:
providing three virtual dice that are displayed on the video display system, a first two virtual dice of the three virtual dice having a plurality of virtual faces and each virtual face having a virtual number indicator, the third virtual die having a plurality of virtual faces and each virtual face having a virtual number indicator, the third virtual die having a visual appearance that is distinct from the visual appearance of the first two dice;
providing in the memory event result tables or paytables having a plurality of outcomes;
the processor receiving a wager on an event result through a signal originating from the data entry system, the at least one wager being on the wagering game;
effecting a virtual casting of the three virtual dice to generate a random event using the electronic random number generator to determine an event outcome,
the random event outcome comprising a display of the three virtual dice consisting of two virtual dice whose exposed virtual numbers are used to define a numeric result corresponding to a particular partial outcome of an event and the third virtual die being used with the particular partial outcome to determine a final event outcome within the game from the event result tables;
comparing the random event of the virtual casting of the three virtual dice with the event result tables or paytables to determine wagering or game events from the random event;
resolving wins or losses based upon the random event; and
f) moving a virtual game piece on a virtual display on the video display system in a continuing of the wagering game; or
g) both resolving wins or losses based upon the random event and moving a virtual game piece on the virtual display system in a finite continuing process of the wagering game.

2. The method of claim 1 wherein the two virtual dice have six virtual faces and each virtual face has a number indicator of only one of 1, 2, 3, 4, 5 or six thereon, and each of the six virtual faces has a different number indicator thereon.

3. The method of claim 1 wherein the third virtual die has six virtual faces and each virtual face has a number indicator of only one of 1, 2, 3, 4, 5 or six thereon, and each of the six virtual faces has a different number indicator thereon.

4. The method of claim 1 wherein a virtual game field surface is displayed on the video display system and is used to display movement of a game piece a virtual amount related to the numeric total of the two virtual dice and the result table associated to the numeric result by a random outcome on the third virtual die according to rules of play of the game stored in the memory.

5. The method of claim 4 wherein the virtual game field surface has markings and words relating the wagering game to a sporting event.

6. The method of claim 5 wherein the sporting event is American Football.

7. The method of claim 6 wherein the event outcome table is separate from the paytable and the event outcome table identifies at least touchdowns, distance of ball movement and penalties according to the combination of numerical result from the two virtual dice and the specific results associated with displayed symbology on the third virtual die.

8. The method of claim 7 wherein after a touchdown occurs in the wagering game, at least one virtual die is recast to determine if an extra point wagering event is achieved.

9. The method of claim 7 wherein proposition wagers are recognized by the processor from the data entry system, the proposition wager being on at least one proposition wager event determined by the virtual casting of the three virtual dice selected from the group consisting of a) a one-roll touchdown; b) a one-roll turnover; c) a one roll penalty; and d) a one roll specific yardage result.

10. The method of claim 7 wherein the event outcome is determined by the processor executing code to compare the virtual gaming event outcome from the virtual casting of the three virtual dice and the event results table.

11. The method of claim 10 wherein proposition wagers is recognized as being on at least one proposition wager event determined by the casting of the three virtual dice selected from the group consisting of a) a one-roll touchdown; b) a one-roll turnover; c) a one roll penalty; and d) a one roll specific yardage result.

12. The method of claim 1 wherein the processor displays at least one of the event result tables on the video display system and indicates virtual game piece movement on a virtual playing field as a result of comparing the random event of the virtual casting of the three virtual dice with the event result tables or paytables to determine wagering or game events from the random event.

13. The method of claim 1 wherein the data entry systems are selected from the group consisting of hand-held wireless communication devices, stand-alone wagering terminals, personal computers on a network or internet and banks of wagering terminals.

14. The method of claim 4 wherein the data entry systems are selected from the group consisting of hand-held wireless communication devices, stand-alone wagering terminals, personal computers on a network or internet and banks of wagering terminals.

15. The method of claim 7 wherein the data entry systems are selected from the group consisting of hand-held wireless communication devices, stand-alone wagering terminals, personal computers on a network or internet and banks of wagering terminals.

16. The method of claim 8 wherein the data entry systems are selected from the group consisting of hand-held wireless communication devices, stand-alone wagering terminals, personal computers on a network or internet and banks of wagering terminals.

17. A gaming system for playing the wagering game of claim 1 comprising:
a) a central processor;
b) a video display system;
c) data entry systems in communication with the central processor;
d) an electronic random number generator in communication with the central processor; and
e) memory containing look-up tables of event result tables;
the video display system displaying an image of both a virtual game piece and a gaming table upper surface with virtual indicia thereon indicating distances and positions for moving a virtual game piece;
the virtual game piece being displayed on the virtual display system at a position on the virtual upper surface; an event result tables or paytables having a plurality of outcomes arranged in rows and columns; and
the video display system displaying three virtual dice, the three virtual dice comprising two virtual dice for defining the numeric result corresponding to a particular partial event on the look-up tables or paytables, and a third virtual die that is visually distinguishable from the two virtual dice for providing a visual appearance that is distinct from the visual appearance of the first two virtual dice, and the third virtual die used to define a number corresponding to a final event outcome defined in the look-up tables or paytables to determine an outcome of that numeric result from the first two dice in event result tables or paytables.

18. The gaming system of claim 17 wherein the indicia represent field position on an American Football playing field and betting areas are provided for placing wagers on at least one of touchdowns, first downs, penalties, turnovers, no touchdowns, and no first downs.

19. The gaming system of claim 17 wherein the data entry system comprise a component selected from the group consisting of wagering terminals, desktop processors with individual display systems, hand-held communication devices and laptop computers.

20. The gaming system of claim 17 wherein the data entry system comprises a portable component selected from the group consisting of cellular phones, wireless tablets, wireless pads and laptop computers.
